(19) United States
(12) Patent Application Publication
(10) Pub. No.: US 2004/0212197 A1
(43) Pub. Date: Oct. 28, 2004

(54) Overhead door locking apparatus and method of operation

(76) Inventor: Rodney Shoemaker, Simi Valley, CA (US)

Correspondence Address: ROBERT J. SCHAAP, Suite 188, 21241 Ventura Boulevard, Woodland Hills, CA, 91364, US

(21) Appl. No.: 10/421,617

(22) Filed: Apr. 22, 2003

(51) Int. Cl. E05C 3/06; E05C 3/16

(52) U.S. Cl. 292/216

(57) ABSTRACT

An overhead door locking apparatus and method which includes a lock housing containing a pivotally mounted locking element having an elongate recess to receive an actuating bolt on or associated with the overhead door. Downward movement of the overhead door to a closed position causes the actuating bolt to pivotally move the locking element, and hold the same in a locked position. An electrically operated solenoid or a mechanical manually operable release arm causes movement therefrom to the unlatched position, allowing the locking element to open. The apparatus and method do not rely upon an electrically operable circuit to cause the door to automatically lock when it moves to the closed position. In this way, the door will automatically lock in the event that personnel overlook the need for locking the same after a certain time period.

### RELATED APPLICATION

This application is based on and claims for priority, the filing date of my U.S. Provisional Patent application Ser. No. 60/368,319, filed Apr. 24, 2002, entitled Overhead Door Locking Apparatus and Method of Operation.

### BACKGROUND OF THE INVENTION

1. Field of the Invention

This invention relates in general to certain new and useful improvements in overhead door locking apparatus and method of operation therefore and more particularly, to an overhead door locking apparatus and method which will allow for automatic locking of the door when the door is moved to a closed position. In this way, security is not compromised in the event that personnel overlook the need for locking the door after a certain time period.

2. Brief Description of Related Art

The vast majority of commercially available overhead door systems allow for opening and closing movement of an overhead door in a track-way comprised of a pair of tracks on opposite sides of the door. Generally, the overhead door will move in a generally vertical path and may also have a horizontal component to the path of movement. Moreover, the tracks are mounted on a frame of the structure which receives the overhead door and a roller system exists between the overhead door and the track-way to allow for movement of the door. The door may consist of a single panel or otherwise, a plurality of hingedly connected panels. The roller arrangement allows for the overhead door to move in the track-way to a closed position from an opened position and vice versa.

Various locking systems are employed to lock the door when in the closed position. In many cases, the locking action is that provided by a door opener. This type of system, in which the door opener is used to provide a locking action is far from fail-safe in that little security is provided by the door opener arrangement. Frequently, that conventional door lock which relies on the use of the opener can be readily opened in the event of a power failure.

Other locking systems rely upon the use of a manually actuable deadbolt. However, the use of a manually operable lock requires personnel to be at the location of the garage door. If the garage door is in the closed position, one at a position outside of the door or at a remote location may assume, without any assurance, that the door is locked. Even if an electrical signal was generated by the opening and closing of the deadbolt, there is still no way of electronically unlocking the garage door from a remote location or otherwise locking the door from that remote location or from the outside thereof.

In my U.S. Pat. No. 6,089,626, dated Jul. 18, 2000, and in my U.S. Pat. No. 6,027,148, dated Feb. 22, 2000, there is described a security device for moveable closure, and particularly a closure in the nature of an overhead door. In that security device, in the form of a lock mechanism, a bolt or pin on a door is movable into a rotatable locking member which is engaged with and is actuated by a rotatable latching member. The latching member, when engaged by the locking element, holds the locking element and hence, the bolt or pin on the door, in a locked position. This mechanism can then be released by a solenoid to cause an opening of the lock mechanism, and which will allow movement of the door.

In the aforesaid locking mechanism described in the two above-identified U.S. patents, there is also a manual release which allows an operator at the door to physically unlock the locking mechanism. However, it has been found that unless personnel are attentive to the fact that the lock mechanism is opened, it will remain opened for a period of time, which may be undesirable, and particularly when there is no monitoring of that particular facility. The present invention provides a modified lock mechanism which will automatically trip a release mechanism to automatically lock a door when it moves to the closed position.

It would be desirable to provide an overhead door locking apparatus which will automatically lock an overhead door when it removes to a closed position which will allow for release of the door either electronically or by manual actuation.

### OBJECTS OF THE INVENTION

It is, therefore, one of the primary objects of the present invention to provide an overhead door locking mechanism which will operate independently of any door opener therefore and permit the door to lock when in the closed position to thereby insure that security offered by the door is always maintained.

It is another object of the present invention to provide an overhead door locking assembly which will allow for locking of a door in a closed position, and which provides for release of the door, either by a mechanically actuable release mechanism or otherwise by an electrical signal from a remote source.

It is a further object of the present invention to provide an overhead door locking assembly, which is completely compatible with and can be operated by or in conjunction with a conventional door opener.

It is an additional object of the present invention to provide an overhead door locking assembly which allows for complete security to ensure that the door is always locked when in the closed position and which is therefor safe, reliable and relatively inexpensive.

It is yet another important object of the present invention to provide a door lock assembly for overhead doors in which installation thereof is relatively simple and which thereby promotes the use and availability of such assembly.

It is another salient object of the present invention to provide a method for securing an overhead door in a closed position and which automatically allows for locking of the door in that closed position, and further allows for mechanically actuable release of the lock mechanism or release through an electrical signal from a remote source.

With the above and other objects in view, my invention resides in the novel features of form, construction, arrangement and combination of parts and components presently described and pointed out in the claims.

### SUMMARY OF THE INVENTION

The present invention resides in a substantial improvement to a lock mechanism of the type described in my aforesaid U.S. Pat. No. 6,089,626 and in my U.S. Pat. No. 6,027,148.

In the lock mechanism of the present invention, there is a substantial improvement to a lock mechanism of the type described in my aforesaid U.S. Pat. No. 6,089,626 and my U.S. Pat. No. 6,027,148. In those two U.S. patents, there is described a mechanism which will automatically lock an overhead door, when a bolt or rod on that door is moved by opening and closing movement of the door into a slot of a locking fork. Pivotal movement of the locking fork will cause a short end on a latching arm to engage the locking fork, and thereby hold the lock in the closed position. In that aforesaid locking mechanism, there is provided a solenoid with means for automatically opening the lock. There is also provided a manual release for opening that lock.

One of the main drawbacks of the locking mechanism described in these aforesaid U.S. patents is the fact that the lock will remain in the unlocked position, if action is not taken to lock the locking mechanism at a later time. Thus, security can be readily breached by mere failure of an attendant or operator to lock a locking element of the locking mechanism.

The present invention overcomes that drawback in the provision of a mechanism which will cause automatic locking of the locking mechanism when a door is closed. In actuality, a release mechanism is tripped so that the lock automatically locks when the door is moved to the closed position. Thus, the present invention provides a means to ensure that there is no potential breach in a security conducted on that door.

More specifically, the present invention provides a pivotally swingable locking actuator which operates in conjunction with a latching arm. The actuator pivots in a clockwise direction and also in a counterclockwise direction about a pivot pin. A locking bolt on the overhead door or otherwise associated with the overhead door is shiftable into the door into a bolt receiving slot formed in the locking actuator. When the locking actuator is pivotally shifted to a first or locking position, it will hold the bolt retentively in that bolt receiving slot and preclude any movement of the overhead door. When the locking actuator is pivotally shifted to a second or open position, the bolt will be able to move out of the bolt receiving slot.

A latching arm is engageable with the locking actuator and is provided with a hooked end to engage the locking actuator and thereby hold the same in a fully locked position. In this way, movement of the bolt out of the bolt receiving slot, when the actuator is in the lock position, is absolutely precluded. However, release of the latching arm from the locking actuator will permit the locking actuator to pivotally rotate back to the position where the bolt can be removed from the bolt receiving slot.

The locking mechanism of the present invention will always cause the bolt associated with the door to be moved into the bolt receiving slot of the locking actuator, when the door is moved to and is in the closed position. Moreover, movement of the door to its fully closed position will cause the bolt to firmly remain in the bolt receiving slot of the locking actuator. As this occurs, the latching arm will latch with the locking actuator and hold the locking actuator in that position so that there is no possibility of the door remaining in the unlocked position when the door is closed.

The locking mechanism of the invention provides a convenient and easily operable door lock release system to enable disengagement of the latching arm with the locking actuator and to permit movement of the bolt out of the bolt receiving slot. This will, in turn, allow for movement of the door.

The lock is openable by a manual release or an electrical release operable from a remote location. In the manual release, an extension on the latching arm is engageable with a microswitch associated with a control circuit, to automatically send a door open signal to a remote control station. The manual release is tripped by a pin on the locking arm to enable an automatic locking of the lock mechanism after a door is moved to the closed position.

The manual release mechanism which permits opening movement of the lock includes a handle having a finger capable of movement into an elongate slot of the lock housing, and enables the handle to rest on the housing holding the lock in the opened position. The handle is pivotally mounted on a swingable movement limiting member, also mounted on the housing in such manner that when the handle is moved to the opened position, the movement limiting member engages the surface of the housing and holds the handle in that opened position.

A pin on the locking arm actually causes the automatic locking of the lock mechanism, as aforesaid. Specifically, the pin engages the handle on the manual release mechanism and shifts the handle to a position where it will no longer hold the lock in the open position. In this way, when the bolt or rod on the door is moved into the locking arm, the entire lock mechanism will shift to a locked position.

One of the unique aspects of the present invention is the fact that the door will remain in the locked position even in the event of a power failure. Thus, there is no possibility of failure of the locking system even with failure of the power system which can operate that locking mechanism. In addition, the invention is unique in that the locking mechanism can function as a manually operated lock mechanism. If the solenoid release feature were removed, the door will still remain in the locked position when the door reaches the closed position.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a fragmentary perspective view showing an overhead door with a track assembly and operable in conjunction with the locking mechanism of the present invention;

FIG. 2 is a top plan view of the major components of a prior art locking mechanism of the type described in the aforesaid U.S. Pat. No. 6,089,626 and in my aforesaid U.S. Pat. No. 6,027,148, and showing the locking mechanism in the open position;

FIG. 3 is a top plan view of the major components of that prior art locking mechanism of FIG. 2, when the locking mechanism is in the locked position;

FIG. 4 is a perspective view, with a side plate of the locking mechanism of the present invention removed, and showing the major components of the locking mechanism of the present invention;

FIG. 5 is an enlarged plan view of the locking mechanism of FIG. 4 and showing an actuator in the opened position to allow for movement of an overhead door;

FIG. 6 is an enlarged plan view, similar to FIG. 5, and showing a locking bolt associated with the door moving into a bolt receiving slot formed in the lock mechanism of the invention, and with the locking actuator therefor still in the unlocked position;

FIG. 7 is an enlarged plan view, similar to FIGS. 5 and 6, and showing the initial movement of the actuator and a latching arm associated therewith when the door has been further moved to a closed position;

FIG. 8 is an enlarged plan view, similar to FIGS. 5-7, and showing the position of the locking bolt and the actuator when the door has been moved to still a further closed position;

FIG. 9 is an enlarged plan view, similar to FIGS. 5-8, and showing the position of the bolt when the door is in the fully closed position and the initial position of a latching arm operable in connection with the actuator; and

FIG. 10 is an enlarged plan view, similar to FIGS. 5-9, and showing the position of a manually actuable release arm and the components associated therewith to release the latching arm from the actuator and allow movement of the bolt and hence the door to an open position.

### DETAILED DESCRIPTION OF A PREFERRED EMBODIMENT

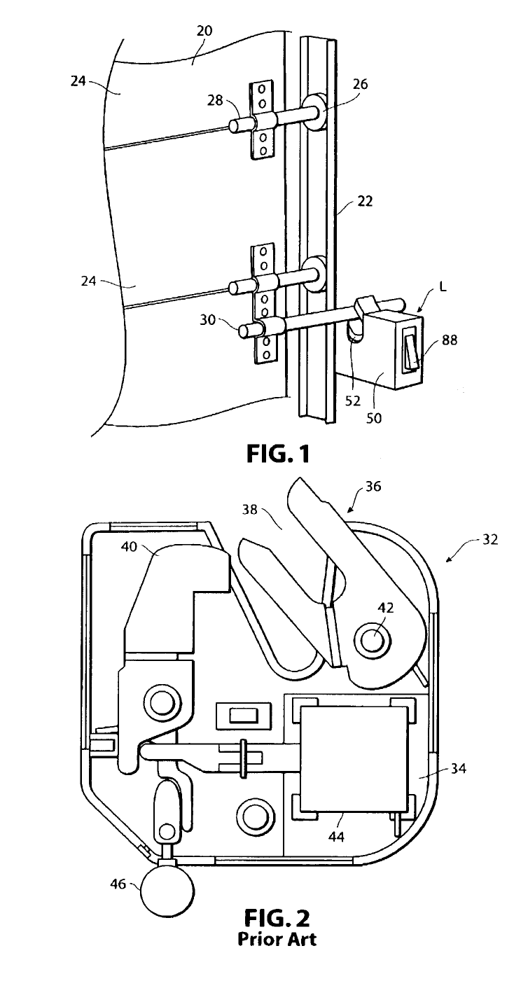

Referring now in more detail and by reference characters to the drawings, FIG. 1 illustrates a simplified schematic movement assembly for allowing movement of an overhead door 20 in a track-way comprised of a pair of spaced apart tracks. In the embodiment as shown, only one track 22 of this pair is illustrated. Moreover, the door 20 is comprised of a door frame (not shown) and a plurality of panels 24. The door frame or the panels 22 hold rollers 26 on roller shafts 28 which are, in turn, secured to the frame or the various panels of the door. In this way, the various panels can hingedly rotate relative to one another during movement of the door in a path in which a portion of the movement is angulated relative to a vertical movement.

FIG. 1 shows the assembly used with a locking mechanism L of the present invention. This locking mechanism L comprises a locking bolt 30 is also mounted on the door 20 and is capable of operating in conjunction with a locking mechanism L of the present invention. In this case, it can be seen that the bolt 30 will be engaged by the locking mechanism L to either preclude movement or to allow movement of the door from an open to a closed position.

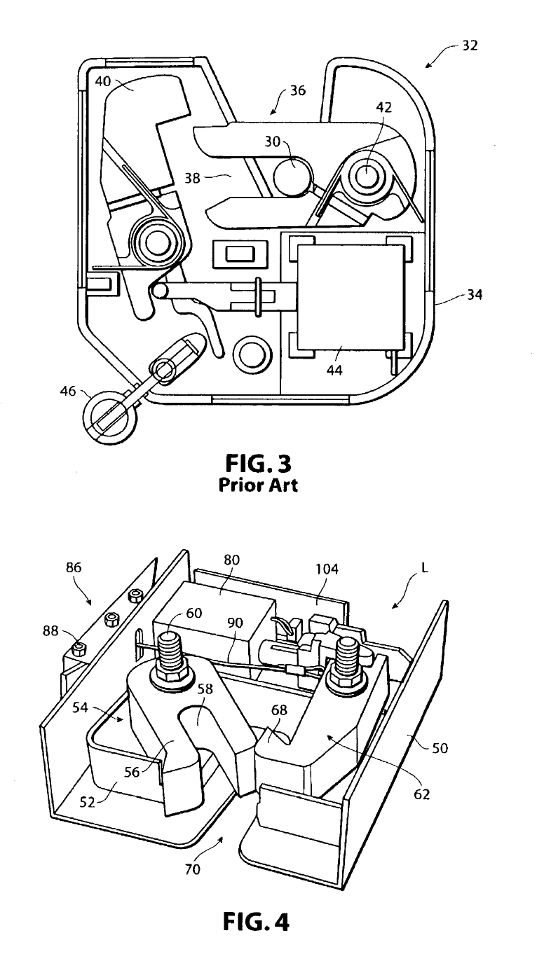

Prior to describing the actual detailed construction and operation of the locking mechanism L of the present invention, reference will be made to a prior art door locking mechanism 32 of the type taught in my aforesaid U.S. Pat. No. 6,089,626, dated Jul. 18, 2000 and in my U.S. Pat. No. 6,027,148, dated Feb. 22, 2000. This prior art locking mechanism 32 is briefly illustrated in FIGS. 2 and 3.

In that aforesaid prior art locking mechanism 32, there is provided an outer housing 34 and a fork-like locking actuator 36 having a bolt engaging slot 38. That actuator 36 was also operable in conjunction with a latching mechanism 40, somewhat similar to, but yet different from the latching arm of the present invention. The actuator 36 was capable of pivotal or rockable movement between a fully opened position as shown in FIG. 2, to a fully locked position, as shown in FIG. 3, about a pivot 42. The latching arm 40 was similarly moveable from a position as shown in FIG. 2, where in the fully unlocking position to a position as shown in FIG. 3, where the locking bolt of the door is engaged by the actuator, but the latching arm has not yet been shifted either manually or electrically to a position where it engages the actuator.

In this arrangement, as shown in FIG. 3, either a solenoid 44 pulled the latching arm 40 to the position as shown in FIG. 3, or otherwise, a manually actuable release handle 46 was manually actuated to cause movement of the latching arm 42 to the opened position as shown in FIG. 3. Manual actuation of the latching arm occurred by manually shifting the position of the actuating arm 46 from that shown in FIG. 2 to that position as shown in FIG. 3. Otherwise, actuation of the solenoid 44 would similarly pull the latching arm 40 to the opened position as shown in FIG. 3.

While the locking mechanism of the type shown in FIGS. 2 and 3 is a highly effective locking mechanism, it does not include the feature of automatically locking the overhead door in the locked position when the door is moved to a fully closed position along with the dual electrical release or mechanically actuable release.

FIG. 4 illustrates those components of the locking mechanism L of the present invention, as aforesaid. This locking mechanism L comprises an outer housing 50 which is generally rectangular in shape as shown in FIG. 1, and includes an elongate bolt receiving opening 70 on an upper portion thereof, as also shown in FIG. 1. This bolt receiving slot 70 is sized and located to receive the bolt 30 in order to either lock movement of the door when the locking mechanism is locked or to permit movement of the door 20 when the locking mechanism L is unlocked. In the embodiment of the invention as shown in FIGS. 4 through 10, one side plate of the housing 50 has been removed to more fully show the interior components of the locking mechanism L.

Referring again to FIG. 4, it can be seen that the locking mechanism L includes a component mounting plate 52 and mounted on that component mounting plate is a fork-shaped locking actuator 54 having a pair of legs 56 separated by a bolt receiving slot 58. The actuator 54 is pivotal on the mounting block 52 by means of a pivot 60.

The actuator 54, which functions as a locking element for locking of the bolt 30, is operable in connection with a latching arm 62 as also shown in FIG. 4. In this respect, the term “bolt” is used in a broad sense to refer to a pin, another arm, a rod, or for that matter any other member capable of fitting into and extending into the elongate slot 58 of the actuator 54. Moreover, it can be observed that the actuator 54 is swingable in an arc, in either a clockwise or a counterclockwise direction, to essentially any of the positions shown in FIGS. 4 through 10, as hereinafter described in more detail.

A latching arm 62 is capable of engaging the locking actuator 54 in the various positions as shown in FIGS. 4 through 10 and either permitting release of the actuator or engagement therewith to hold the actuator and hence the bolt in the slot 58 in a locked position. For the purpose of allowing easy movement of the bolt 30 into and out of the elongate slot 58, that slot is defined by an arcuately shaped corner 64 which readily and easily allows the bolt 30 to extend into the slot 58. At its outer end, that same leg of the actuator 54 is provided with somewhat of a hook-shaped end 66. This hook shaped end on the one leg of the actuator 54 is engageable by a hook 68 on the latching arm 62. Thus, when the bolt 30 first enters the bolt receiving opening 70 and the elongate bolt receiving slot 58, the movement of the door will push the actuating arm in and cause rotation of same about the pivot 60 in a counter-clockwise direction.

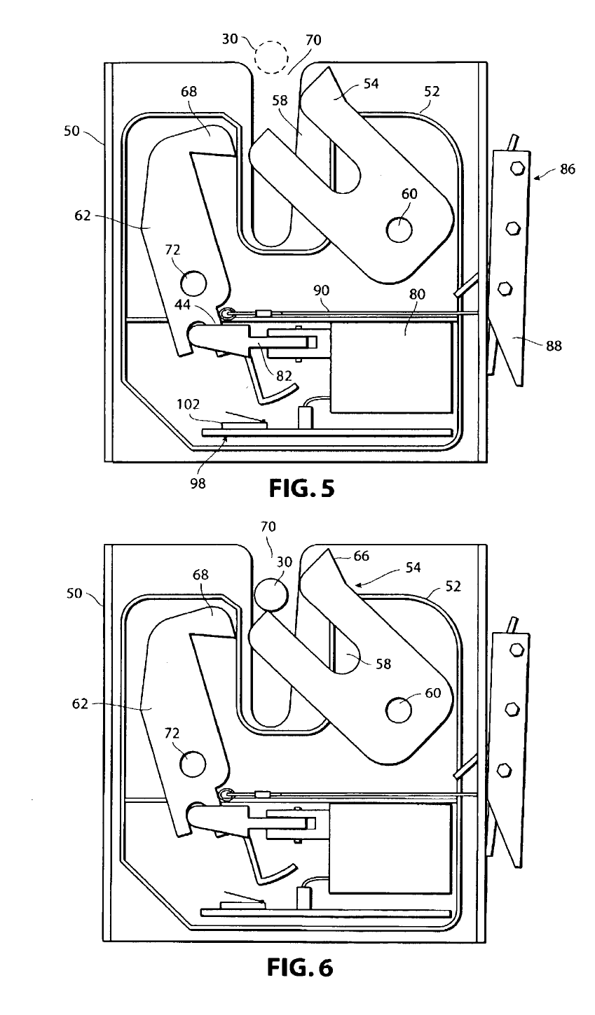

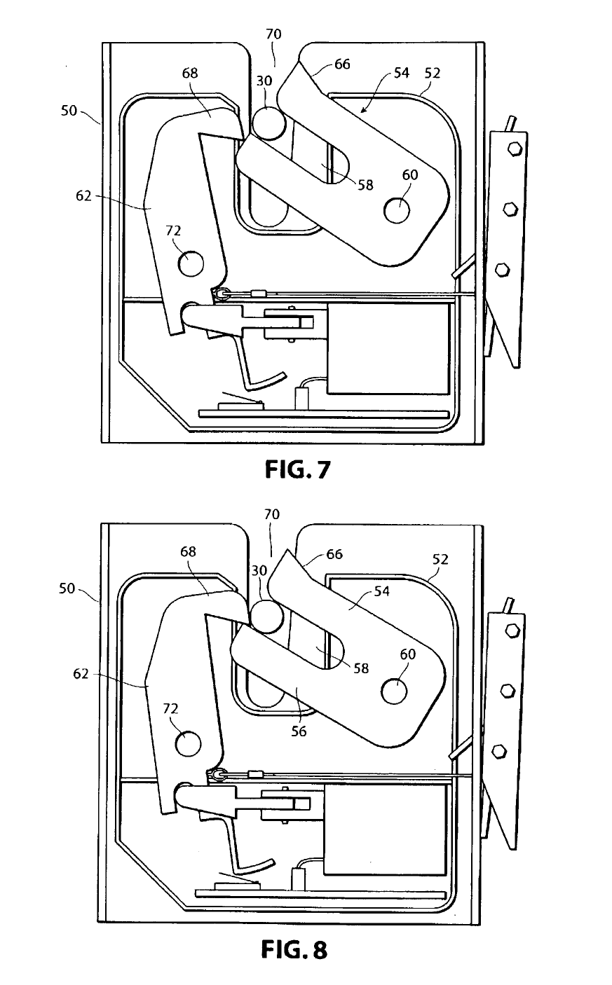

FIG. 5 illustrates the position of the bolt 30 just as it is about to enter into a receiving opening 70 in the housing 34. FIG. 6 illustrates the position of the bolt relative to the actuator and the slot 58 of the actuator as the bolt 30 has been moved into the bolt receiving opening 70. FIG. 7 shows the position of the bolt 30 when the actuator 34 has been further rotated in the counter-clockwise direction and the entry of the bolt 30 into the bolt locking slot 58. Finally, FIGS. 8, 9 and 10 show the position of the bolt 30 and the relative position of the actuator 54 as the actuator is further rotated in a counter-clockwise direction to fully lock the bolt 30 in the locking slot 58. In this respect, FIG. 10 shows the position of the bolt 30 relative to the locking slot 58.

It can be observed that the latching arm 62 is pivotally mounted on a pivot 72 and is pivotal only in a limited arc between the position shown in FIG. 10 to the position shown in FIG. 7. In the position as shown in FIG. 7, the latching arm 62 is riding along an end of one leg of the actuator 54, where it has been depressed to its furthermost position above pivot pin 72 in the counter-clockwise direction. The latching arm is thereafter capable of being allowed to pivot in the clockwise direction about the pivot 72 to that position shown in FIG. 10.

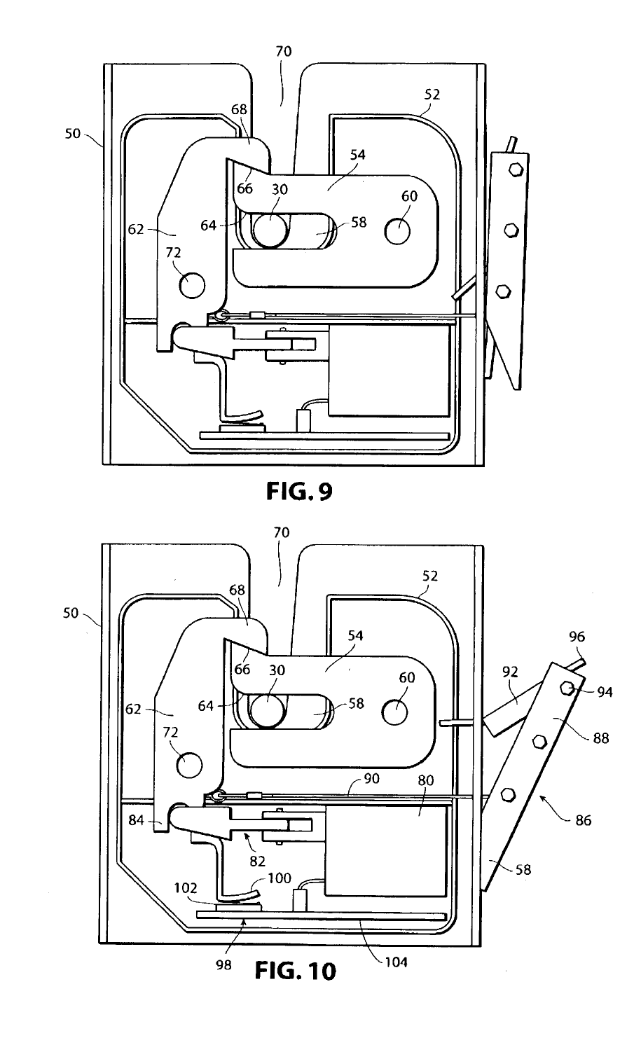

The latching arm primarily serves the function of holding and locking the actuator 34 in the locked position as best shown in FIGS. 9 and 10 of the drawings. The latching arm 62 is biased to rotate in a clockwise direction by means of a torsion spring 74 disposed about the pivot 72. In this way, the latching arm 62 will be forced into locking engagement with the actuator.

The locking actuator 54 is also biased to pivot in the clockwise direction about the pivot 60, by means of a torsion spring 61. Although this biasing mechanism for the locking actuator can be eliminated and still obtain operation, it is a preferred component, since the latching arm is biased, such that it holds the locking actuator in the locked position unless released therefrom.

More specifically, when a garage door 20 is moving down the track-way 22 to a closed position, the locking actuator 54 will be in a position, as shown in FIG. 4 and then in FIG. 5. Continued movement of the door toward the closed position, will cause the locking bolt 30 to move in the lock retaining slot 58 in the actuator 54. During this movement, the latching arm 62 essentially remains in the position, as shown in FIGS. 5 and 6, although a torsion spring 74 about the latching arm 62 biases the same to rotate in a clockwise direction. However, it can be seen that the actuator 54 bears against the latching arm, causing the same to remain in the opened position of FIGS. 4-6.

Further movement of the door to a closed position will cause rotation of the locking actuator 54, to a position as shown in FIG. 7, and then in FIG. 8. Further movement of the door to the closed position will thereupon cause the locking actuator 54 to be moved to the fully closed position, as shown in FIGS. 9 and 10. In this case, the locking bolt 30 has reached its innermost limit of travel in the lock receiving opening 70.

When the latching arm 62 is moved about the pivot point 72 in the counterclockwise direction, it can be observed that a reverse of those positions, as set forth in FIGS. 4-10, will take place. In other words, when the latching arm is pulled down to its fully extended position in the counterclockwise direction, the locking actuator 54 will be allowed to move through the various positions as shown in FIGS. 5-9, back to the position as shown in FIG. 4. In this way, the bolt 30 will be removed from the elongate locking slot 58, and also from the opening 70, so that the door can be moved to the opened position.

It can be observed that the hooked end 68 on the latching arm 62, will physically engage a hook-shaped end 66 on the arm 56, of the locking actuator 54. This will hold the locking actuator 54 in the fully locked position, until such time as the latching arm 62 is physically released, and pulled to its furthermost counterclockwise position, as for example, as best shown in FIG. 8.

By virtue of the construction thus far described, it can be seen that the locking actuator will be held in a locked position by the latching arm and will, hence, capture the bolt 30 in the actuator 54, at any time that the door is moved to the fully closed position. In this way, the door will automatically be locked by the locking mechanism of the present invention. This may be accomplished in place of a door opener, or otherwise, it will provide an additional locking action in addition to that provided by the door opener. The only time that the door can be moved to the opened position is when the latching arm is pulled to the furthermost position in the counterclockwise direction, releasing the latching arm and allowing the bolt 30 to be moved out of the bolt receiving slot 58.

As indicated previously, the locking mechanism of the invention can be released, that is, it can be opened, by a manual actuator, or otherwise, by an electrical signal from a remote source. The release mechanism of the present invention is different from that illustrated in the former locking mechanisms, as exemplified by the prior art illustrations of FIGS. 2 and 3. In the embodiment of the invention as shown, there is a solenoid 80. The solenoid 80 is provided with a linkage assembly 82, and which engages a forked end 84 on the latching arm 62. That is, at the end opposite the hook 68. When the solenoid is energized by an electrical signal from a remote source, the linkage 82 is pulled upwardly. As this occurs, the hook 68 on the latching arm, is removed from engagement with the locking actuator 54, and against the action of the torsion spring 74. As the hook-shaped end 68 is pulled away from engagement with the locking actuator 54, it will be allowed to pivot in the clockwise direction, and allow the bolt 30 to be removed from the locking slot 58. It should be understood that the solenoid 80 would be connected to a remote signal mechanism, such as a switch, by means of an electrical conductor, which is not shown for purposes of clarity.

The locking mechanism of the invention can also be released by means of a manual actuation, as aforesaid. Thus, the present invention provides a manual release assembly 86, which includes a manually engageable release arm 88, as best shown in FIGS. 1, 5 and 10 of the drawings. When the handle 88 is pulled upwardly to the position as shown in FIG. 10 of the drawings, it will pull upon a cable 90, as best shown in FIGS. 5 and 10. As this occurs, it can be observed that the latching arm 62 will also, again, be pulled in its counterclockwise direction against the action of the torsion spring 74 about the pivot pin 72. As this occurs, the latching arm will be moved back to the position as shown in FIG. 6, and will allow the locking actuator to shift to the position, also shown in FIG. 6 and FIG. 4. Moreover, the manual release handle 88 can be held in the opened position by means of a locking tab 92, which is pivotal on the handle 88, by means of a pivot pin 94. When the locking tab 92 is released, merely by pushing down on a tab 96, the locking handle 88 will be pulled back down to the position as shown in FIG. 5. As this occurs, the torsion spring will allow the locking actuator to be shifted to the locking position.

The locking mechanism of the present invention may also be provided with a security signal generating component 98, as best shown in FIGS. 5 and 10 of the drawings. In this case, the security generating signal component comprises a reversely bent tab 100, on an extension of one of the legs 84 of the forked end of the latching arm 62. This tab 100 will engage a microswitch 102, and cause a remote signal to be sent to a security station. This remote signal would thereupon indicate to a security station that the lock mechanism of the invention has been opened. When the tab 100 is removed from engagement with the microswitch 102, the signal to that security station will then be released. For this purpose, the microswitch 98 could be powered from the electrical current, also delivered to the solenoid 80, or it could be powered by a separate electrical conductor.

The microswitch 102 can also be mounted on a printed circuit board 104 containing a control circuit. Thus, the circuit board could operate as a type of control center for merely sending a control signal to a remote source, which will either energize a light or other signal advising that the door is opened. It should also be understood that the control circuit 104 on the circuit board could similarly be wired so as to send a signal when the locking mechanism is locked.

Thus, there has been illustrated and described a unique and novel locking mechanism which automatically allows for the locking of an overhead door on each occasion when that door is moved to the fully closed position. This locking mechanism also allows for an easy and convenient release, either electrically or by mechanism actuation. The locking mechanism thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. A locking mechanism for automatically locking an overhead door when that door is moved to a closed position and which allows for movement back to an opened position upon actuation of the locking mechanism to provide for opening thereof, said mechanism comprising:
a) a locking actuator which can be shifted from an unlocking position to a locking position, when a member on a door is shifted into an opened area thereof; and
b) a pivotal latching arm engageable with the locking actuator and holding the same in a locked position or allowing movement to an unlocked position in response to the position of the latching arm; and
c) means operatively associated with at least one of said locking actuator or latching arm to automatically cause the relocking of the locking mechanism when the door reaches the closed position so that the door is automatically locked in the closed position.

2. The locking mechanism of claim 1 further characterized in that said locking mechanism further comprises:
a) electronic release means operatively connected to at least one of said locking actuators or said latching arm and causing pivotal movement to a position where the locking element is released allowing movement to a position where it can hold the locking actuator in a locked position; and
b) manual release means operatively connected to said latching arm and allowing for opening thereof.

3. The locking mechanism of claim 1 further characterized in that the means to automatically cause a relocking of the locking mechanism comprises a biasing means for biasing the latching arm to cause engagement with the locking actuator to hold same in a locking position and thereby lock the door when in a closed position.

4. The locking mechanism of claim 1 further characterized in that the locking actuator is provided with an elongate slot to receive a member on a door and will lock that member in a locked position until the actuator is pivotal to an unlocking position.

5. The locking mechanism of claim 4 further characterized in that the latching arm is biased to engage with and hold the locking actuator in a locked position until the latching arm is released from engagement with the actuator.

6. The locking mechanism of claim 5 further characterized in that the locking actuator is biased to rotate to an unlocking position unless restrained by the action of the latching arm.

7. The locking mechanism of claim 4 further characterized in that said latching arm has a hook on an end thereof and said locking actuator has a hook on an end thereof such that the hook on the latching arm will engage the hook on the locking actuator and thereby hold same in the locked position.

8. The locking mechanism of claim 2 further characterized in that said manual release means is connected to said latching arm in such position so as to pull the latching arm out of engagement with the locking actuator to thereby cause a release of the locking action.

9. The locking mechanism of claim 8 further characterized in that said electronic release means causes a physical movement of the latching arm to a position where it does not engage the locking actuator upon energization thereof and thereby causes a release of any locking action.

10. A method of maintaining security for an overhead door by locking the overhead door whenever that door is in the closed position, said method comprising:
a) inserting a projecting member on the door into a locking actuator when the door is moved to a closed position;
b) causing a latching arm to engage the locking actuator and hold that locking actuator in a locked position when the door is moved to the closed position; and
c) releasing the latching arm from engagement with the locking actuator and allowing the locking actuator to unlock the member on the door when the latching arm is shifted to a position where it can no longer engage the locking actuator.

11. The method of claim 10 further characterized in that said method comprises either manually releasing the locking actuator from engagement with the locking actuator or electronically releasing the latching arm from engagement with the locking actuator, to thereby permit opening of the door.

12. The method of claim 10 further characterized in that said method comprises biasing said latching arm to a position where it will always tend to engage the locking actuator and hold the locking actuator in a locked position.

13. The method of claim 12 further characterized in that said latching arm is always biased to a position where it will permit unlocking of the member on the door and thereby allow the door to be moved to the opened position unless it is restrained against movement by the latching arm.

14. The method of claim 10 further characterized in that said method comprises moving the member in the door into a slot in the locking actuator and causing pivotal rotation of the locking actuator to a position where the member cannot be removed from the slot until such time as the actuator is pivotally moved back to its original position.

15. The method of claim 10 further characterized in that a security advisory signal is sent to a remote source when the locking actuator is rotated to an unlocking position allowing movement of the door away from the closed position.

16. A locking mechanism for automatically locking an overhead door when that door is moved to a closed position and only authorizedly allowing movement of the door back to the opened position, said locking mechanism comprising:
a) a locking actuator having an elongate slot to receive a member on the door as the door is moved to the closed position, said member initially causing rotation of the locking actuator to a position where the member on the door is further restrained in the locking actuator; and
b) a latching arm engageable with said locking actuator and holding that locking actuator in a position where the member on the door cannot be removed from the slot until such time as the latching arm becomes disengaged from the locking actuator.

17. The locking mechanism of claim 16 further characterized in that said locking mechanism further comprises:
a) electronic release means operatively connected to at least one of said locking actuator or said latching arm and causing pivotal movement to a position where the locking member is released allowing movement to a position where it can hold the locking actuator in a locked position; and
b) manual release means operatively connected to said latching arm and allowing for opening thereof.

18. The locking mechanism of claim 16 further characterized in that said latching arm is provided with a hook on an end thereof and said locking actuator is provided with a hook on an end thereof and said locking actuator is provided with a hook on an end thereof and where the hook on the latching arm will engage the hook on the locking actuator to hold same in the locked position until the latching arm is released from the locking position.

19. The locking mechanism of claim 16 further characterized in that said locking actuator is biased to move to the unlocking position where it will release the member on the door from the elongate slot unless restrained by the action of the latching arm.
